(19) United States
(12) Patent Application Publication
(10) Pub. No.: US 2026/0021753 A1
(43) Pub. Date: Jan. 22, 2026

(54) FITTING FOR A VEHICLE SEAT

(71) Applicant: Brose Fahrzeugteile SE & Co. Kommanditgesellschaft, Coburg, Coburg (DE)

(72) Inventor: Peter SCHWARZE, Ahorn (DE)

(21) Appl. No.: 19/106,291

(22) PCT Filed: Aug. 16, 2023
(86) PCT No.: PCT/EP2023/072551

§ 371 Date: Mar. 14, 2025

(30) Foreign Application Priority Data
Aug. 25, 2022 (DE) 10 2022 208 805.0

(51) Int. Cl. B60N 2/235; B60N 2/22

(52) U.S. Cl. CPC B60N 2/2354; B60N 2/2227

(57) ABSTRACT

A fitting for a vehicle seat with a first seat element and a second seat element. The fitting includes a first fitting adapter, which is arranged fixedly on the first seat element, with a locking disc, and a second fitting adapter, which is mounted pivotably in relation to the first fitting adapter, with a locking pawl. The locking pawl is mounted on a first bearing point of the second fitting adapter so as to be pivotable between an open position releasing the pivoting movement and a locking position locking the pivoting movement. In the locking position, the locking pawl engages in a form-fitting manner at least in part in a locking receptacle of the locking disc, and the locking disc has a stop on which the first bearing point is supported.

The invention relates to a fitting for a vehicle seat having a seat part and having a backrest, in particular for a front seat of a motor vehicle, the fitting comprising a fitting adapter which is fixed to the seat part and has a blocking disk, and comprising a fitting adapter which is mounted so as to be pivotable relative to the aforementioned fitting adapter, which is fixed to the backrest and has a pawl. The invention also relates to a vehicle seat for a motor vehicle, comprising a fitting of said type.

Vehicle seats in motor vehicles typically have backrests which are foldable or pivotable in order, for example, to vary an inclination of the backrest. By way of example, such a vehicle seat comprises a seat part, a backrest and a fitting by which the backrest is connected, pivotably about a pivot axis by means of a pivot mechanism, to the seat part. Here, the fitting has a seat-part-side fitting adapter, which is connected fixedly to the seat part, and a backrest-side fitting adapter, which is coupled via a blocking mechanism to the backrest. The fitting adapters are connected to one another via the pivot mechanism such that the seat-part- side fitting adapter and the backrest-side fitting adapter can be pivoted relative to one another about the pivot axis.

The inclination of the backrest relative to the seat part is adjusted by virtue of the backrest-side fitting adapter being pivoted relative to the seat-part-side fitting adapter manually or by means of an electric motor. Here, during a normal adjustment of the backrest inclination, the backrest-side fitting adapter is coupled fixedly via the blocking mechanism to the backrest. For this purpose, the blocking mechanism is situated in a blocking setting such that, when the backrest-side fitting adapter pivots, the backrest is pivoted together with the backrest-side fitting adapter about the pivot axis.

The blocking mechanism can however be actuated in order to decouple the backrest-side fitting adapter from the backrest, in order to enable the backrest to be freely pivoted manually and without the actuation of a drive device (so-called free pivoting function). Such free pivoting of the backrest may be provided in order for the backrest to be folded into a horizontal setting in the context of a so-called easy-entry function. An easy-entry function is to be understood here to mean a convenience function of a vehicle seat, in particular of a front seat in the case of two-door and three-door motor vehicles, which allows particularly wide and comfortable access to the rear seats.

Such easy-entry front seat fittings (locks) thus allow the front seat backrest to be folded or pivoted in order to allow access to the second row. These locks, in an open setting, rotationally release the backrest or a backrest frame from the pivot mechanism (recliner) and, when the lock is open, thus allow the backrest frame to rotate relative to the pivot mechanism. When the lock is closed (closed setting), the backrest frame is fixedly connected to the pivot mechanism and can thus transmit shear forces and torques thereto. The lock should be designed such that, even in a crash situation, said lock holds the backrest in a defined position relative to the seat surface and secures the backrest against unintentionally folding forward.

The blocking or lock mechanism generally has a fixed blocking disk on the seat- part-side fitting adapter and a pivotably mounted pawl on the backrest-side fitting adapter, which blocking disk and pawl form-fittingly engage with one another in the blocking setting. Typically, for the actuation of the pawl, a rotary latch (friction lobe) which is pivotable about a bearing journal is arranged on the backrest-side fitting adapter and crash-resistantly locks the pawl in the blocking setting.

In the locked state, the friction lobe closes the pawl, wherein the pawl is centered in or on the blocking disk and is thus locally free from play in the region of engagement. Owing to manufacturing and assembly tolerances, such locks may however exhibit a certain residual amount of play in the closed state. In particular in the region of a bearing point of the pawl, radial play may arise which persists, and is perceptible or measurable at the backrest, even in the locked state. It is however generally desired that the additional lock mechanism does not give rise to any additional play at the backrest.

In order to eliminate play in the lock or blocking mechanism of easy-entry locks, it is known for example from DE 102 06 299 A1 to provide a separate adjustable element as an adjustable stop for the blocking disk on the backrest-side fitting adapter, said adjustable element forming a load path for rearward forces and thus rendering the bearing point free from play with respect to the pawl. Such adjustable elements disadvantageously require an additional adjustment operation during the assembly of the vehicle seat, making the assembly process relatively complex and expensive.

The invention is based on the object of specifying a particularly suitable fitting for the vehicle seat. The invention is also based on the object of specifying a particularly suitable vehicle seat.

According to the invention, said object is achieved with regard to the fitting by means of the features of claim 1, 10 or 19, and with regard to the vehicle seat by means of the features of claim 23. The respective dependent claims relate to advantageous embodiments and refinements. The advantages and embodiments discussed with regard to the fitting are analogously also transferable to the vehicle seat, and vice versa.

The fitting according to the invention is provided as a lock for a vehicle seat of a motor vehicle, and is suitable and configured for this purpose. Here, the vehicle seat has a first seat element and a second seat element, wherein the fitting connects the second seat element pivotably about a pivot axis to the first seat element.

For this purpose, the fitting has a first fitting adapter and a second fitting adapter which is mounted so as to be pivotable relative to said first fitting adapter. In the assembled state, the first fitting adapter is fixedly joined to the first seat element, and, in the assembled state, the second fitting adapter is fixedly joined to the second seat element.

The fitting is designed in particular as a front-seat fitting for a vehicle front seat. The fitting is preferably designed as an easy-entry front-seat fitting or as an easy- entry lock (EE lock) for a vehicle front seat with easy-entry functionality. The first seat element is in this case preferably designed as a seat part, and the second seat element is preferably designed as a backrest of the vehicle seat. The first seat element will hereinafter also be referred to, without loss of generality, as seat part, and the second seat element will hereinafter also be referred to, without loss of generality, as backrest. The first fitting adapter is in this case fixedly connected to the seat part, in particular to a seat substructure, whereas the second fitting adapter is fixedly connected to the backrest, in particular to a backrest frame or backrest support.

A fixed blocking disk is arranged on the fitting adapter which is fixed to the seat part, hereinafter also referred to as seat adapter, and a pivotably mounted pawl is arranged on the fitting adapter which is fixed to the backrest, hereinafter also referred to as backrest adapter. The pawl is arranged on a first bearing point of the backrest adapter so as to be pivotable between an open setting, in which the pivoting movement of the seat and backrest adapters is enabled, and a blocking setting, in which the pivoting movement is blocked. The first bearing point is for example designed as a protruding bearing bolt or bearing journal on which the pawl is pivotably (rotationally, rotatably) mounted.

In the blocking setting, the pawl form-fittingly engages at least in part into a blocking receptacle of the blocking disk, such that the relative rotational or pivoting movement of the backrest adapter with respect to the seat adapter is blocked.

Here and below, a “form fit” or a “form-fitting connection” between at least two interconnected parts is to be understood in particular to mean that the coherence between the interconnected parts at least in one direction is provided by direct interlocking of contours of the parts themselves or by indirect interlocking via an additional connecting part. The “blocking” of a relative movement in this direction is thus geometry-based.

Here, the blocking disk has a stop on which the first bearing point is supported when the pawl is in the locked blocking state. In other words, the bearing point that supports the pawl is in contact with the stop of the blocking disk. A particularly suitable stop for a vehicle door is thus realized.

To fix or lock the pawl in the blocking setting, a first blocking element or securing element is preferably provided in the form of a rotary latch, which is arranged pivotably on the backrest adapter.

The first blocking element may for example be designed as an articulated lever. The first blocking element is however preferably designed as a friction lobe and will hereinafter be referred to-without loss of generality-as first friction lobe.

The first friction lobe is spring-loaded or preloaded by means of a first spring element, for example, into a locking setting, in which the pawl is locked in the blocking setting.

In one advantageous embodiment, in the locking setting, the first friction lobe presses the pawl into the blocking receptacle such that the pawl is at one side pressed with an end face against a support surface of the blocking receptacle and is at the other side pressed against the first bearing point. In particular, the blocking receptacle has no further counterbearing for supporting the pawl, such that, in the blocking setting, the pawl is supported only on the bearing point and on the support surface.

The pawl thus presses without play against the first bearing point when in the closed (blocking) state on the blocking disk. In particular, radial play that exists between the first bearing point and the pawl is eliminated owing to the support of the pawl on the first bearing point. The fitting thus presses without play against the first bearing point itself, and therefore requires no additional adjustment operation during the assembly process. The angles of contact of the locking components (blocking element/friction lobe) are expediently configured such that the tolerances can be compensated by the fitting itself. Therefore, no adjustment operation for the purposes of compensating play is required during the assembly of the fitting, and an EE mechanism that is free from play in the locked blocking state is nevertheless realized.

The dissipation of load or support (of forces) in the event of a crash thus takes place only via the support surface or the first bearing point. In particular, in the event of a rear-end crash, load is dissipated via the bearing point and the stop, and in the event of a front-end crash, load is dissipated via the pawl end face against the support surface of the blocking disk. A play-free and crash-resistant stop is thus realized.

In one conceivable embodiment, the first bearing point is supported directly on the stop. This means that, when the pawl is in the locked blocking state, there is mechanical contact between the first bearing point and the stop. It is thus ensured that the pawl is reliably pressed without play against the first bearing point.

For example, the pawl has a leadthrough opening into which the first bearing point is inserted. This means that the first bearing point is circumferentially fully enclosed by the pawl. In this case, the direct support is preferably realized in an offset plane. This means that the stop lies against and supports the first bearing point in a plane that is parallel and offset with respect to the pawl plane.

In an embodiment that is particularly compact in terms of structural space, the pawl engages substantially in a C shape around the first bearing point. This means that the first bearing point is circumferentially not fully enclosed by the pawl. Here, the C opening of the encompassing C shape is dimensioned such that the bearing point is radially form-fittingly enclosed such that the pawl cannot be undesirably released from the bearing point. In other words, the clear width of the C opening is dimensioned to be smaller than the diameter of the bearing point. Here, in the locked blocking state, the first bearing point is expediently supported by the stop in the region of the C opening. This means that the stop engages in part into the C opening of the pawl. The C opening is thus oriented so as to be oriented toward the stop when the pawl is in the blocking state.

In a stable embodiment that has a reduced component requirement, the stop is formed integrally on, that is to say as a single piece or monolithically with, the blocking disk.

In one suitable embodiment, in the blocking setting, the pawl engages into the blocking receptacle substantially along the entire length of the pawl proceeding from the first bearing point, that is to say from the bearing point to the end face abutting against the support surface. Here, the blocking receptacle is preferably of tooth-free design. This allows the end face of the pawl to abut against the support surface of the blocking receptacle over a particularly large area.

The blocking receptacle may however also be of toothed form in order to realize an additional crash safeguard in the event that the stop of the blocking disk deflects. Here, the pawl has at least one appropriately corresponding tooth contour for engagement purposes. In the blocking state, the tooth contour lies with an end face against the support surface, wherein the tooth contour otherwise has a clear spacing to the tooth contour(s) of the blocking disk, thus ensuring that load is transmitted to the first bearing point.

According to an additional or a further aspect of the invention, on the backrest adapter, there is arranged a pivotably mounted second blocking element or securing element in the form of a rotary latch, which is spring-loaded by means of a second spring element into the locking setting. The second blocking element is preferably designed as a friction lobe and will hereinafter be referred to—without loss of generality—as second friction lobe.

The blocking elements or friction lobes preferably have different angles of friction or angles of contact with the pawl in the locking setting. In particular, the first friction lobe has a greater angle of friction than the second friction lobe. For example, the second friction lobe has a friction angle of between 0° and 3°, and is thus oriented substantially perpendicularly to the pawl. In particular, the second friction lobe provides a crash safeguard for the blocking mechanism, which in the event of a crash prevents the pawl from being released from the blocking receptacle. The first friction lobe has a relatively large angle of friction, for example of between 5° and 15°, in particular of between 8° and 10°, preferably of approximately 9°, and serves in particular for eliminating play from the fitting in the locked blocking state. Owing to the combination of two friction lobes having a small angle of friction and having a relatively large angle of friction for the purposes of eliminating play, the larger tolerance chain does not need to be adjusted by means of a separate process. Owing to the functional separation of the crash safeguard and the elimination of play, the lock or the fitting has sufficient compensation capability to compensate the tolerance chain. The first friction lobe will hereinafter also be referred to as play friction lobe (play elimination friction lobe), and the second friction lobe will hereinafter be referred to as a crash friction lobe (crash safeguard friction lobe).

The locking state of the play friction lobe is self-locking owing to the spring force of the first spring element and the friction resistance at the contact point with respect to the pawl. The play friction lobe preferably has a curved contact area with respect to the pawl. The center point of the radius of curvature is in this case offset with respect to the axis of rotation or pivot axis of the second bearing point. The curved contact area and the relatively large angle of friction give rise to an opening tendency or an opening moment for the plate friction lobe, allowing a particularly smooth and easy release of the locking action.

With respect to the pawl, the crash friction lobe has an offset in relation to the play friction lobe. In other words, the crash friction lobe normally does not lie against the pawl. Thus, in the locking state, the pawl is locked only by the play friction lobe. If this locking action is however undesirably eliminated owing to an acting force caused by the increased opening moment, the crash friction lobe provides crash-resistant locking of the pawl as a safeguard. The crash friction lobe thus prevents an undesired folding movement of the backrest in the event of a crash.

In one conceivable embodiment, the friction lobes are mounted pivotably on a common bearing point. This ensures an arrangement of the friction lobes which is particularly compact in terms of structural space, such that the fitting can be installed in a particularly space-saving manner.

In one expedient refinement, the second friction lobe or the crash friction lobe is coupled to a Bowden cable. The crash friction lobe is preferably furthermore coupled in terms of actuation to the play friction lobe. This means that the play friction lobe is coupled indirectly via the crash friction lobe to the Bowden cable. Here, the Bowden cable is guided to, and actuatable by means of, an actuating lever of the backrest. The friction lobe—and thus the locking of the pawl—is thus actuatable by means of the Bowden cable, such that the free-pivoting or easy-entry function of the fitting can be reliably and easily triggered by means of the Bowden cable.

The two friction lobes each have a dedicated spring element. The spring rates/stiffnesses or preloads can thus be adapted to the desired function of the particular friction lobe. Here, the first spring element is relevant for the play elimination function of the play friction lobe, wherein the second spring element is relevant for retracting the Bowden cable and for ensuring that the locking setting is assumed for the crash safeguard provided by the crash friction lobe.

In one suitable embodiment, the spring elements of the friction lobes are arranged in parallel with respect to one another in terms of their direction of action. The spring elements thus act substantially mutually independently on the associated friction lobes, whilst these are however actuated or triggered substantially simultaneously. The spring elements may thus be designed as identical parts. For example, the spring elements are in this case designed as spiral springs (compression springs, helical springs), in particular as curved spiral springs (bow springs), which are each supported at a fixed end on a holding contour of the backrest fitting and which at the free end lie against the associated friction lobe.

In an alternative embodiment that is also suitable, the spring elements are arranged in series with respect to one another in terms of their direction of action. The first spring element for the play friction lobe is in this case preferably supported directly on the crash friction lobe. The working range of the first spring element is thus reduced to the tolerance compensation range. Because the spring elements are connected in series, the second spring element must be dimensioned to be of considerably greater stiffness than the first spring element, because the spring elements act counter to one another in the closed or locked state. Here, the spring elements are not designed as identical parts; in particular, the spring elements are designed as left-handed and right-handed variants (LH/RH) in relation to one another. The actuating forces are however advantageously reduced in sum total, because only the second spring element has to cover the entire actuation travel.

In one expedient embodiment, the first spring element is designed as a torsion spring (rotary spring), preferably as a leg spring having two spring legs, wherein the first spring leg is coupled to the first friction lobe, and the second spring leg is coupled to the second friction lobe. A structurally simple and reliable series connection of the spring elements is thus realized.

According to an additional or further aspect of the invention, a first microswitch is arranged on the fitting adapter that is fixed to the backrest, said first microswitch detecting a setting of the pawl, and/or a second microswitch is arranged on the fitting adapter that is attached to the backrest, said second microswitch detecting a setting of the first and/or second friction lobe.

In one conceivable embodiment, the second friction lobe and the pawl each have an associated microswitch. The switching signal from the second microswitch of the crash friction lobe indicates whether the easy-entry lock (fitting) is open or closed, that is to say whether or not the pawl is locked. The switching signal of the first microswitch of the pawl preferably indicates whether the backrest is being folded or (freely) pivoted. In particular, the first microswitch is in this case triggered only if the backrest is being folded/pivoted forward. It is advantageously thus possible for the securing element (crash friction lobe) to be interrogated directly, such that triggering of an electrical seat rail adjustment occurs only when the backrest is pivoted forward. Here, the seat part is movable along a seat rail by means of the seat rail adjustment. In the context of the EE function, the seat rail adjustment causes the seat part to be moved in particular into a forward rail position in order to thus increase the free space for access to the second row.

In an alternative embodiment that is also conceivable, only the pawl is assigned a microswitch, thus reducing the structural space requirement. In this case, the first microswitch is preferably actuated when the pawl is in the locked blocking setting. This first microswitch is for example triggered already at a nominal 1.7° folding or inclination angle of the backrest, and is preferably used for triggering the electrical seat rail adjustment and for an unlocked-state indicator. For example, an insert- molded wiring harness that makes contact with the microswitch is integrated in a housing of the backrest adapter.

In one advantageous refinement, the pawl has a projection formed integrally thereon, that is to say as a single piece or monolithically therewith, as an actuating arm for actuating the first microswitch. Here, the first microswitch is preferably actuated when the pawl is situated in the open position and the backrest is pivoted forward.

A projection is formed integrally on the first or second friction lobe for the purposes of actuating the second microswitch.

The vehicle seat according to the invention is provided for a motor vehicle, and is suitable and configured for this purpose. Here, the vehicle seat is designed in particular as a front seat in a two-door or three-door motor vehicle. The vehicle seat has a seat part and a backrest and a fitting as described above. The fitting is designed in particular as an easy-entry lock, such that the vehicle seat is equipped with easy-entry functionality. A particularly suitable vehicle seat is thus realized.

Exemplary embodiments of the invention will be discussed in more detail below on the basis of a drawing. In the drawing:

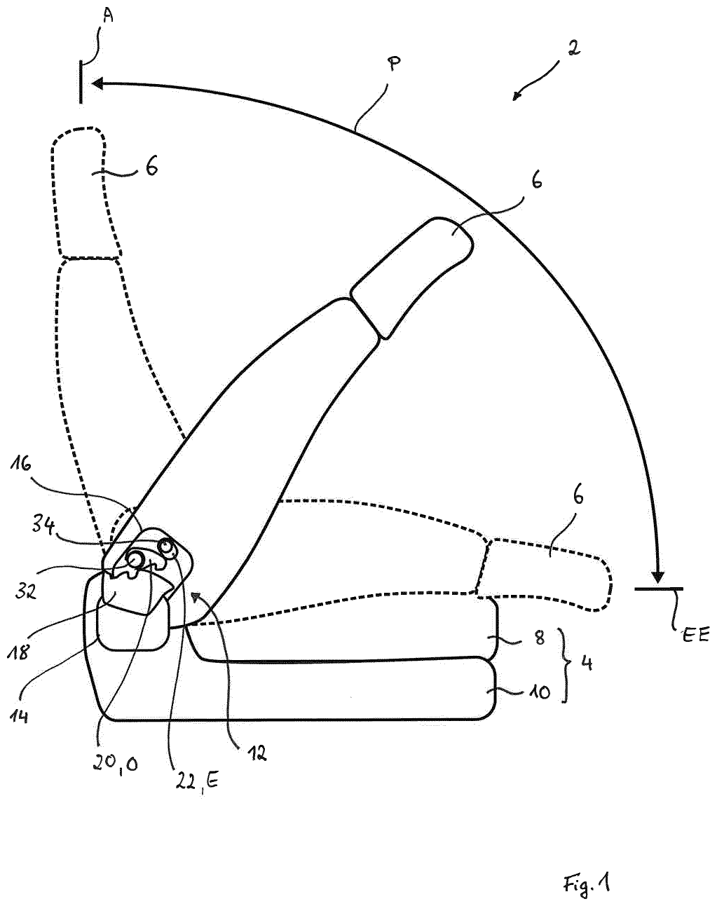

FIG. 1 is a schematic illustration of a vehicle seat having a seat part, having a backrest and having a fitting according to the invention,

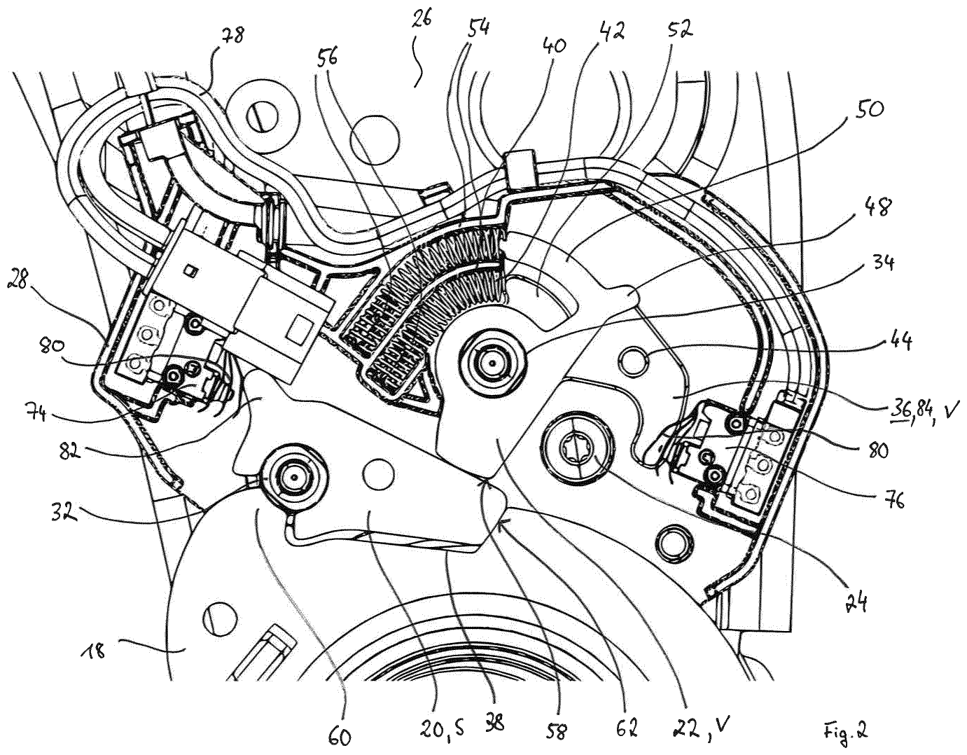

FIG. 2 is a detail plan view of the fitting,

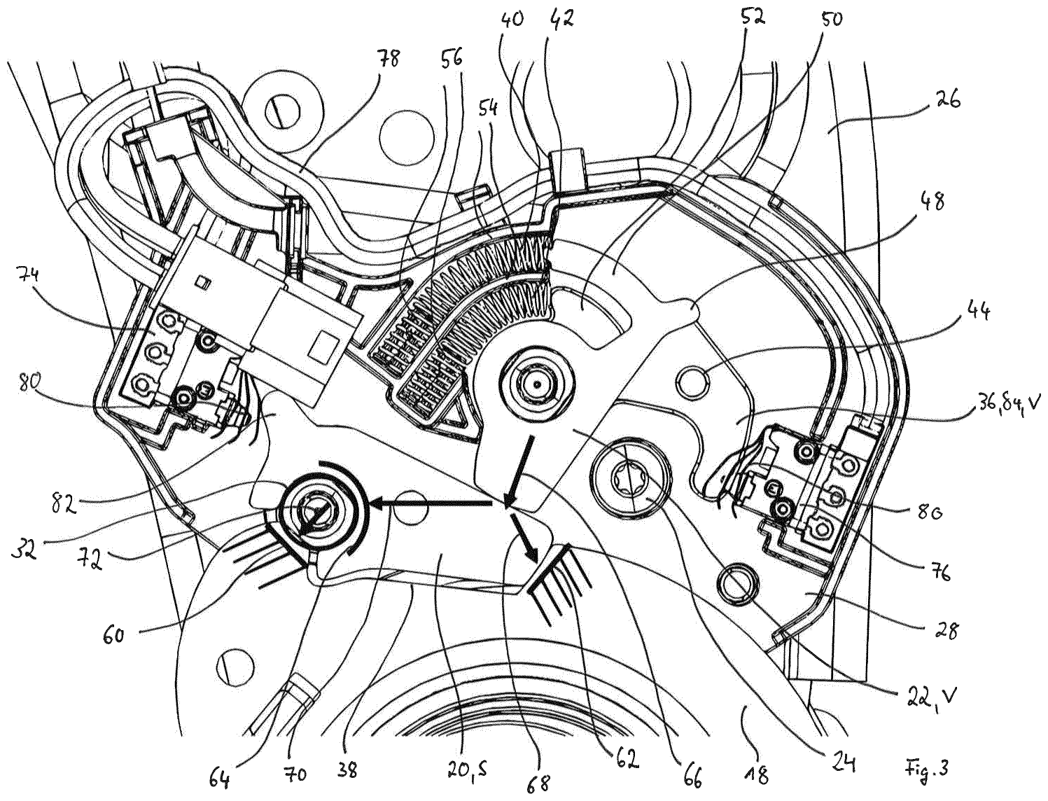

FIG. 3 is a detail plan view of the fitting according to FIG. 2, with load paths schematically indicated,

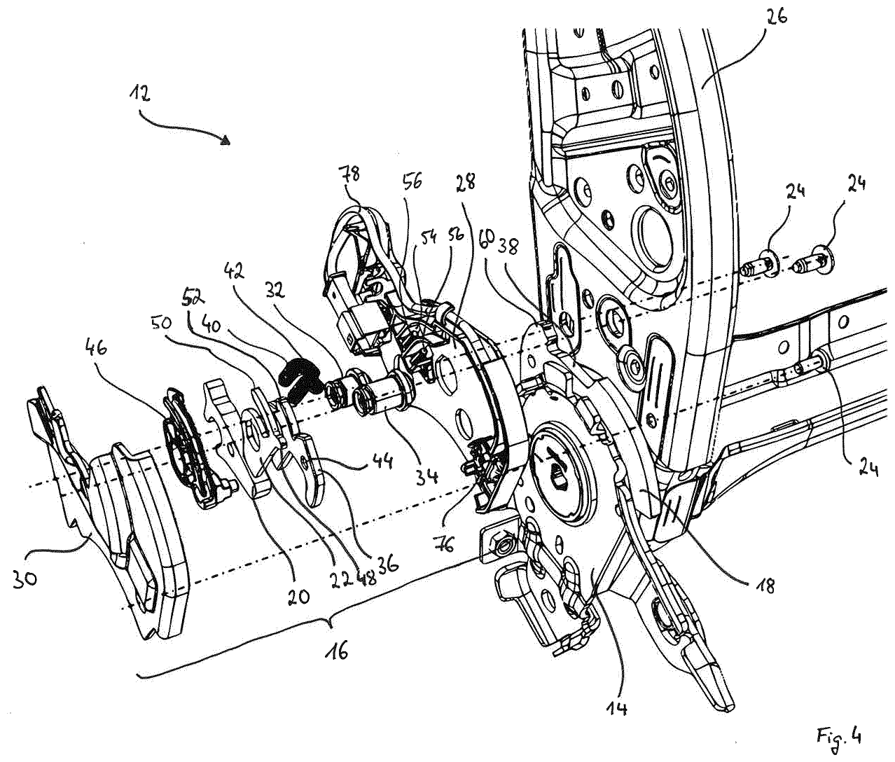

FIG. 4 is a perspective exploded illustration of the fitting,

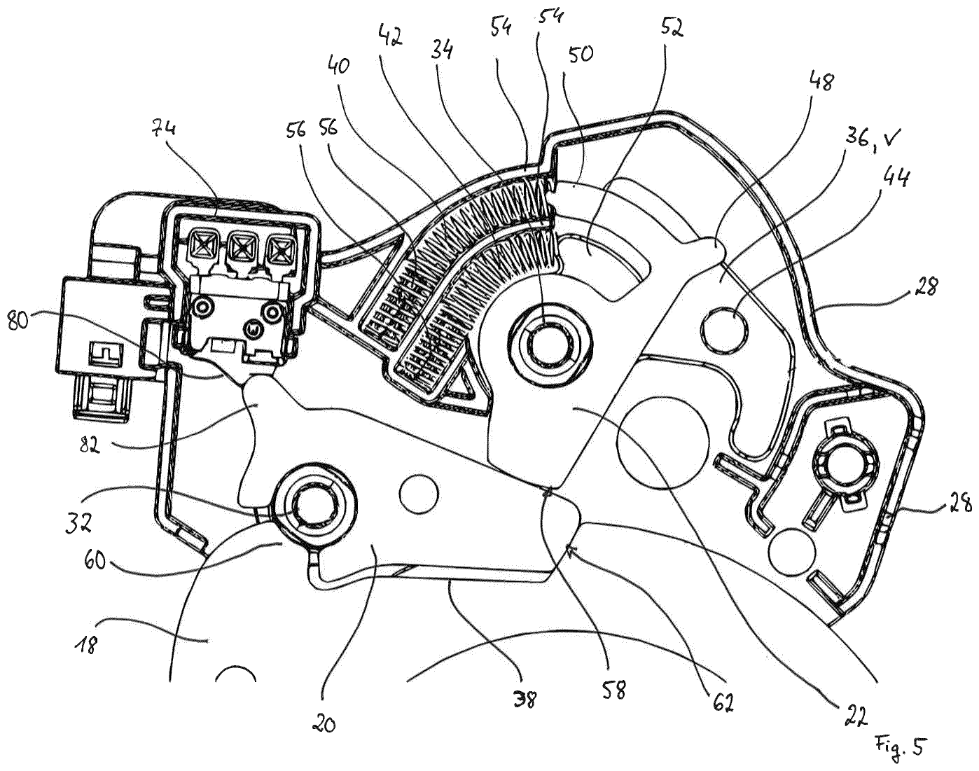

FIG. 5 is a detail plan view of the fitting in a second embodiment, and

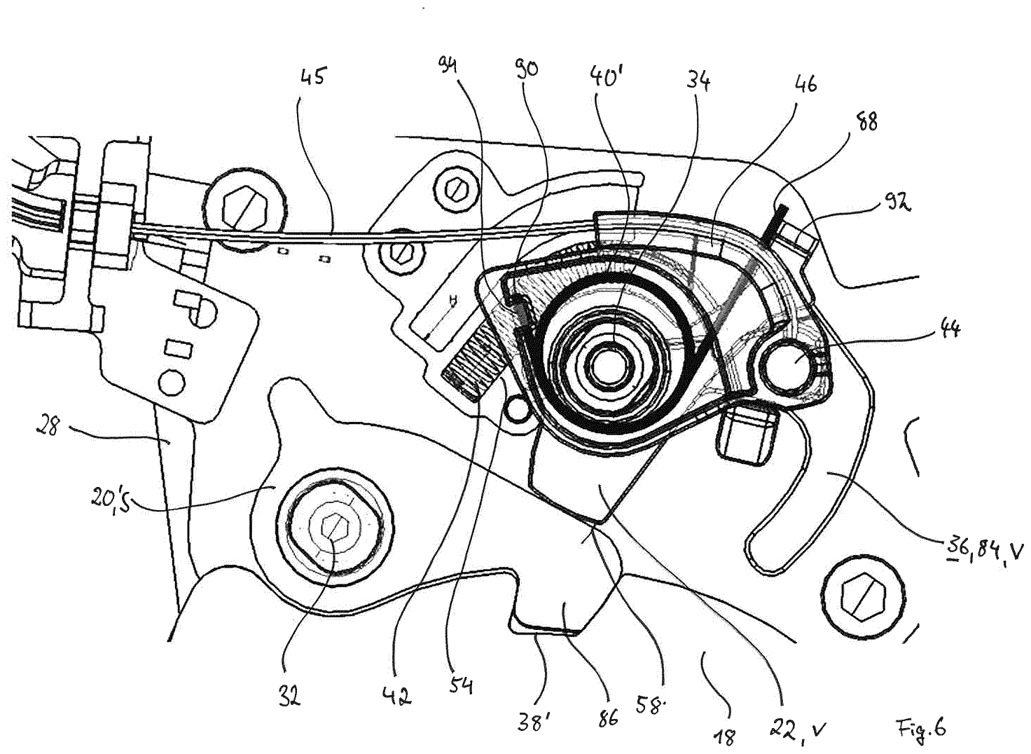

FIG. 6 is a detail plan view of the fitting in a third embodiment.

Mutually corresponding parts and dimensions are denoted by the same reference designations throughout the figures.

FIG. 1 shows, in a simplified schematic illustration, a vehicle seat 2 having a first seat element 4 designed as a seat part and having a second seat element 6 designed as a backrest. Here, the seat part 4 has for example a seat surface 8 and a seat substructure (seat support) 10. In the assembled state, the seat substructure 10 is fixedly connected to a vehicle body. The vehicle seat 2 is designed for example as a front seat of a two-door or three-door motor vehicle.

The seat part 4 and the backrest 6 are foldably or pivotably coupled by means of a fitting 12. The fitting 12 is preferably designed as an easy-entry lock.

Here, the fitting 12 has a fitting adapter (seat adapter) 14 which is fixedly connected to the seat part 4 or to the seat substructure 10, and a fitting adapter (backrest adapter) 16 which is coupled to the backrest 6. The fitting 12 furthermore has a blocking mechanism for blocking the pivoting capability.

The blocking mechanism comprises a fixed blocking disk 18, which is arranged on the seat adapter 14, and a pawl system, which is arranged on the backrest adapter 16 and which has a pawl 20 and at least one blocking element 22 designed as a friction lobe.

The inclination of the backrest 6 relative to the seat part 4 is adjusted by virtue of the backrest adapter 16 being pivoted relative to the seat adapter 14 manually or by means of an electric motor. During a normal adjustment of the backrest inclination, the fitting 12 or the blocking mechanism thereof is situated in a closed position, such that the backrest adapter 16 is coupled fixedly via the blocking mechanism to the backrest 6. The backrest 6 is thus also pivoted or folded together with the backrest adapter 16. When the fitting 12 is in an open setting, the backrest adapter 16 is decoupled from the backrest 6, such that the backrest 6 can be freely pivoted manually and without actuating an electric seat rail adjustment.

When the fitting 12 is actuated, the backrest 6 is thus adjustable in terms of its (backrest) position P. Here, the backrest 6 is reversibly movable between an approximately vertical upright setting A, which represents the highest possible position P, and an approximately horizontal easy-entry setting EE, which represents the lowest possible position P. In FIG. 1, the backrest 6 is indicated in each of these settings A and E using dashed lines. By contrast, solid lines are used to illustrate the backrest 6 in a half-inclined intermediate setting.

The construction and the function of the fitting 12 will be discussed in more detail below on the basis of FIGS. 2 to 6.

FIG. 2 to FIG. 4 show a first embodiment of the fitting 12.

The backrest adapter 16 is in particular cohesively welded to a backrest frame 26 of the backrest 6. Three screw elements 24 are fixedly joined to the backrest frame 26 for the purposes of fastening a lock (of a lock assembly) of the fitting 12. The housing-like backrest adapter 16 has a lock support 28 as a housing base and has a cover plate (lock cover) 30 as a housing cover of the lock. The lock support 28 and the cover plate 30 are for example formed as injection-molded parts. The lock support 28 and the cover plate 30, when assembled, form a (plastics) housing of the lock or of the lock assembly. The pawl system of the blocking mechanism is accommodated in the housing interior thus formed. The illustrations in FIG. 2 and FIG. 3 show the backrest adapter 16 with the cover plate 30 having been removed.

Two perpendicularly protruding bearing journals as bearing points 32, 34 are arranged on the lock support 28 and are fixed by means of two screw elements 24. The pawl 20 is mounted pivotably on the bearing point 32, with two pivotable friction lobes as blocking elements 22, 36 being arranged on the bearing point 34.

The pawl 20 is arranged on the bearing point 32 so as to be pivotable between an open setting O, in which the pivoting movement of the seat and backrest adapters 12, 16 is enabled, and a blocking setting S, in which the pivoting movement is blocked. As can be seen in particular in FIGS. 2 and 3, in the blocking setting S, the pawl 20 form-fittingly engages at least in part into a blocking receptacle 38 of the blocking disk 14, such that the relative rotational or pivoting movement of the backrest adapter 16 with respect to the seat adapter 14 is blocked.

In order to fix or lock the pawl 20 in the blocking setting S, the friction lobes 22, 36 as locking rotary latches are pivotable about the bearing point 34. Here, the friction lobes 22, 36 are each arranged on the bearing point 34 so as to be pivotable between a locking setting V and an unlocking setting E. The friction lobes 22, 36 have mutually coaxially arranged leadthrough openings by which the friction lobes 22, 36 are mounted on the bearing point 34. In the locking setting V, the friction lobes 22, 36 block a movement of the pawl 20 such that it is locked in the blocking receptacle 38. In the unlocking setting E, the locking action is eliminated, such that the pawl 20 can be moved out of the blocking receptacle 38 into the open setting O.

The friction lobes 22, 36 are each spring-loaded or preloaded into the locking setting V by a respectively associated spring element 40, 42. In the locking setting V, the friction lobes 22, 36 have different angles of contact or angles of friction with the pawl 20. Here, the friction lobe 22 has a greater angle of friction than the friction lobe 36.

In the exemplary embodiment illustrated in FIG. 2 and FIG. 3, the friction lobe 36 has a friction angle of 0° and is therefore perpendicular to the pawl 20. In particular, the friction lobe 36 provides a crash safeguard for the blocking mechanism, which in the event of a crash prevents the pawl 20 from being released from the blocking receptacle 38. The friction lobe 36 will hereinafter also be referred to as crash friction lobe.

The friction lobe 22 has a relatively large angle of friction of approximately 9°, and serves in particular for eliminating play of the fitting 12 in the locked blocking state. The friction lobe 22 will hereinafter also be referred to as play friction lobe.

The crash friction lobe 36 has an attachment point 44 for coupling to a Bowden cable 45 (FIG. 6). Here, the Bowden cable 45 is guided in the backrest adapter 16 by means of a coupling part 46. The crash friction lobe 36 is coupled in terms of actuation to the play friction lobe 22, such that the play friction lobe 22 is actuatable by means of the Bowden cable indirectly via the crash friction lobe 36.

For the coupling in terms of actuation, the play friction lobe 22 has a driver arm 48 formed integrally thereon, that is to say as a single piece or monolithically therewith. In the assembled state, the coupling part 46 engages with the hole-like attachment point 44. When actuated, the crash friction lobe 36 is pivoted in the direction of the spring element 42, such that the spring element 42 is compressed. During the course of the pivoting movement, the coupling part 46 is pivoted against the driver arm 48, such that the play friction lobe 22 is driven along by the coupling part 46. The resulting pivoting movement of the play friction lobe 22 causes the spring element 40 to be compressed.

The two friction lobes 22, 36 each have a dedicated spring element 40, 42, such that the spring rates/thicknesses or preloads can be adapted to the desired function of the particular friction lobe 22, 36. Here, the spring element 40 is relevant for the play elimination function of the play friction lobe 22, wherein the spring element 42 is relevant for retracting the Bowden cable and for ensuring that the locking setting V is assumed for the crash safeguard provided by the crash friction lobe 36.

In the exemplary embodiment of FIG. 2 to FIG. 4, the spring elements 40, 42 are arranged in parallel with respect to one another in terms of their direction of action. Here, the friction lobes 22, 36 each have a protrusion 50, 52 formed integrally thereon, that is to say as a single piece or monolithically therewith, as a contact point with respect to the associated spring element 40, 42. The protrusions 50, 52 are in this case designed to be curved along the pivoting travel. The spring elements 40, 42 are designed as identical parts in the form of spiral or helical 10 springs (bow springs). Here, the spring elements 40, 42 are received in a curved or accurate arrangement within spring receptacles 54 of the lock support 28. A pin 56 is arranged in each of the spring receptacles 54, onto which pins the spiral- shaped spring elements 40, 42 are mounted.

With respect to the pawl 20, the crash friction lobe 36 has an offset in relation to the play friction lobe 22. In other words, the crash friction lobe 36 normally does not lie against the pawl 20. The crash friction lobe 36 is thus somewhat shorter than the play friction lobe 22 in the direction of the pawl 20.

Thus, in the locking state, the pawl 20 is locked by the play friction lobe 22. If this locking action is however undesirably eliminated owing to an acting force, the crash friction lobe 36 provides crash-resistant locking of the pawl 20 as a safeguard.

The locking state of the play friction lobe 22 is self-locking owing to the spring force of the spring element 40 and the friction resistance at the contact point with respect to the pawl 40. As can be seen for example in FIG. 2, the play friction lobe 22 has a curved contact area 58 with respect to the pawl. The central point of the radius of curvature of the contact area 58 is in this case offset with respect to the axis of rotation or pivot axis of the bearing point 34, resulting in smooth locking and unlocking by means of the play friction lobe 22.

The pawl 20 has a leadthrough opening for receiving the bearing point 32. The leadthrough opening is in this case open toward the outer periphery of the pawl 20, such that the pawl 20 engages substantially in a C shape around the bearing point 32. In the closed setting S, the C opening of the leadthrough opening is in this case oriented toward a protruding stop 60. The stop 60 is formed integrally on the blocking disk 18 and in the blocking state engages into the C opening. In particular, the stop 60 is in contact with the bearing point 32.

In the exemplary embodiment in FIG. 2 to FIG. 4, the blocking receptacle 38 is of tooth-free design, wherein, in the blocking setting S, the blocking element 20 engages into the blocking receptacle 38 substantially along the entire length of the pawl proceeding from the bearing point 32. Here, the pawl 20 is supported with an end face against an oblique support surface 62 of the blocking receptacle 38. The pawl 20 and the support surface 62 have a relatively large contact area, wherein the support surface 62 has an angle of inclination of for example 20°. In other words, the support surface 62 encloses an obtuse angle of approximately 110° with a base of the blocking receptacle 38.

In the region of the leadthrough opening, the pawl 20 has a certain amount of radial play with respect to the bearing point 32. This radial play is eliminated by means of the play-eliminating action of the play friction lobe 22 in the blocking state. The elimination of play will be discussed in more detail below on the basis of FIG. 3. FIG. 3 corresponds to the illustration in FIG. 2, with schematic arrows additionally being plotted for the purposes of indicating the transmission of force or load. The stop 60 and the support surface 62 are illustrated schematically in FIG. 3 as fixed surfaces. The radial play is indicated in FIG. 3 by an arc 64 that is spaced from the bearing point 32.

In the locking setting V, the play friction lobe 22 presses the pawl 20 with the relatively large angle of friction of 9° into the blocking receptacle 38 (arrow 66). In this way, the pawl 20 is at one side pressed with an end face against the support surface 62 (arrow 68) and is at the other side pressed against the bearing point 32 (arrow 70). The bearing point 32 is thus the counterbearing with respect to the support surface 62. The pawl 20 is thus pressed without play into the blocking receptacle, and, in particular, the radial play is expressed in relation to the bearing point 32, with the bearing point 32 being pressed against the stop 60 (arrow 72). Therefore, in the blocking state, the bearing point 32 is directly mechanically supported against the stop 60 of the blocking disk 18.

In the embodiment of FIG. 2 to FIG. 4, two microswitches 74, 76 are arranged on the lock support 28 of the backrest adapter 16. The microswitches 74, 76 are arranged on opposite narrow sides of the lock support 28 and are connectable by means of a partially insert-molded wiring harness 78 to an on-board electrical system for signal transmission purposes.

The microswitch 74 is provided and configured to detect a setting of the pawl 20, wherein the microswitch 76 is provided and configured to detect a setting of the crash friction lobe 36. Here, the microswitches 74, 76 each have a spring-mounted (switching) lever 80, which in FIGS. 2 and 3 is shown in each case in three different switching settings. The microswitches 74, 76 are oriented such that the levers 80 project into the housing interior, that is to say in the direction of the pawl 20 or of the crash friction lobe 36.

To actuate the microswitches 74, 76, actuating protrusions are formed integrally on the pawl 20 and on the crash friction lobe 36, which actuating protrusions, in the event of a movement of the associated component 20, 36, trigger the respectively associated microswitch 74, 76 or lever 80.

The pawl 20 has a projection 82 formed integrally thereon, that is to say as a single piece or monolithically therewith, in the form of an actuating arm or actuating protrusion, said projection protruding obliquely from the pawl body of the pawl 20. When the pawl 20 pivots from the blocking setting S into the open setting O, the projection 82 is pivoted so as to depress the lever 80 and thus trigger the microswitch 74.

A projection 84 is formed integrally on, that is to say as a single piece or monolithically with, the crash friction lobe 36 and is oriented approximately perpendicularly with respect to that portion of the crash friction lobe 36 which ensures the locking action. When the crash friction lobe 36 pivots from the unlocking setting E into the locking setting V, the projection 84 is pivoted so as to depress the lever 80 and thus trigger the microswitch 76.

The switching signal from the microswitch 76 of the crash friction lobe 36 indicates whether the fitting 12 is open or closed, that is to say whether or not the pawl 20 is locked. The switching signal from the microswitch 74 of the pawl 20 indicates whether the backrest 6 is being folded or (freely) pivoted. In particular, the microswitch 74 is in this case triggered only if the backrest 6 is being folded/pivoted forward. It is advantageously thus the case that the securing element (crash friction lobe 36) is interrogated directly, such that triggering of an electrical seat rail adjustment occurs only when the backrest 6 is pivoted forward.

FIG. 5 shows a second embodiment of the fitting 12 or of the backrest adapter 16, in which the microswitch 76 for the crash friction lobe 76 is omitted. Thus, only the pawl 20 is assigned the microswitch 74, thus reducing the structural space requirement in the housing interior of the backrest adapter 16. The fitting 12 is thus particularly compact in terms of structural space.

In this embodiment, the microswitch 74 is actuated by the projection 82 when the pawl 20 is in the locked blocking setting S. This first microswitch 74 is for example triggered already at a nominal 1.7° folding or inclination angle of the backrest 6, and is preferably used for triggering an electrical seat rail adjustment and for an unlocked-state indicator.

FIG. 6 shows a third embodiment of the fitting 12 or of the backrest adapter 16. The coupling part 46 is illustrated in semitransparent form in FIG. 6.

In this embodiment, the pawl 20′ is equipped with a tooth contour 86 on the end face, which tooth contour engages with a complementarily formed tooth-shaped locking receptacle 38′. Here, the pawl 20′ fully encompasses the bearing point 32.

In this embodiment, too, the pawl 20′ is pushed without play into the locked state. For this purpose, the tooth contour 86 lies only with an end face against the support surface 62, wherein the other surfaces of the tooth contour 86 have a clear spacing to the blocking receptacle 38′, such that the bearing point 32 acts as a counterbearing. The stop 60 for the bearing point 32 is in this case arranged in a plane that is offset in parallel with respect to the plane of the drawing, such that an elimination of play is made possible even in the case of a closed or encompassed bearing point 32.

The embodiment in FIG. 6 furthermore differs in terms of the arrangement of the spring elements 40′, 42. In this variant, the spring elements 40′, 42 are arranged in series with respect to one another in terms of their direction of action.

Here, the spring element 40′ is designed as a leg spring having two spring legs 88, 90, wherein the spring leg 88 lies against an integrally formed protrusion 92 of the play crash lobe 22, and wherein the spring leg 90 is fixed to a holding contour 94 of the coupling part 46. Here, the protrusion 92 is formed substantially as an elongated driver arm 48. The coupling part 46 is in this case connected via the attachment point 44 to the crash friction lobe 36, such that the spring leg 90 is indirectly coupled to the crash friction lobe 36. Alternatively, the spring element 40′ for the play friction lobe 22 may be supported directly on the crash friction lobe 36.

The claimed invention is not restricted to the exemplary embodiments described above. Rather, a person skilled in the art may also derive other variants of the invention from these within the scope of the disclosed claims, without departing from the subject matter of the claimed invention. In particular, all individual features described in conjunction with the various exemplary embodiments may also be combined in other ways within the scope of the disclosed claims, without departing from the subject matter of the claimed invention.

For example, the implementation of the spring loading by means of the spring elements 40, 40′, 42 is inventive on its own and thus constitutes an independent invention.

The monitoring by means of the microswitches 74, 76 also constitutes an independent invention.

### LIST OF REFERENCE SIGNS

2 Vehicle seat
4 Seat element, seat part
6 Seat element, backrest
8 Seat surface
10 Seat substructure
12 Fitting
14 Fitting adapter, seat adapter
16 Fitting adapter, backrest adapter
18 Blocking disk
20, 20′ Pawl
22 Blocking element/(play) friction lobe
24 Screw element
26 Backrest frame
28 Lock support
30 Cover plate
32 Bearing point
34 Bearing point
36 Blocking element/(crash) friction lobe
38, 38′ Blocking receptacle
40, 40′ Spring element
42 Spring element
44 Attachment point
45 Bowden cable
46 Coupling part
48 Driver arm
50 Protrusion
52 Protrusion
54 Spring receptacle
56 Pin
58 Contact area
60 Stop
62 Support surface
64 Arc
68, 70, 72 Arrow
74 Microswitch
76 Microswitch
78 Wiring harness
80 Lever
82 Projection
84 Projection
86 Tooth contour
88 Spring leg
80 Spring leg
94 Holding contour
P Backrest position
A Backrest setting, upright setting
EE Backrest setting, easy-entry setting
O Open setting
S Blocking setting
V Locking setting
E Unlocking setting

1-23 (canceled)

24. A fitting for a vehicle seat having a first seat element and a second seat element, the fitting comprising:
a first fitting adapter fixedly mounted to the first seat element, said first fitting adapter having a blocking disk formed with a blocking receptacle and with a stop;
a second fitting adapter pivotally mounted relative to said first fitting adapter and fixedly mounted to the second seat element;
said second fitting adapter having a pawl that is pivotably arranged on a first bearing point of said second fitting adapter for pivoting between an open setting, in which a pivoting movement is enabled, and a blocking setting, in which the pivoting movement is blocked;
said pawl, in the blocking setting, engaging form-fittingly at least in part into said blocking receptacle of said blocking disk; and
said first bearing point being supported on said stop of said blocking disk.

25. The fitting according to claim 24, further comprising a first blocking element pivotably mounted on said second fitting adapter, said first blocking element being spring-loaded by a first spring element into a locking setting, in which said pawl is locked in the blocking setting.

26. The fitting according to claim 25, wherein, in the locking setting, said first blocking element presses said pawl into said blocking receptacle to thereby press said pawl with an end face against a support surface of said blocking receptacle on one side and against said first bearing point on another side.

27. The fitting according to claim 24, wherein said stop is integrally formed on said blocking disk.

28. The fitting according to claim 24, wherein, in the blocking setting, said pawl engages into said blocking receptacle substantially along an entire length of said pawl proceeding from said first bearing point.

29. A fitting for a vehicle seat having a first seat element and a second seat element, the fitting comprising:
a first fitting adapter fixedly mounted to the first seat element;
said first fitting adapter having a blocking disk formed with a blocking receptacle;
a second fitting adapter fixedly mounted to the second seat element and pivotally relative to said first fitting adapter;
said second fitting adapter having a pawl that is pivotably arranged on a first bearing point of said second fitting adapter between an open setting, in which a pivoting movement is enabled, and a blocking setting, in which the pivoting movement is blocked;
said pawl, in the blocking setting, form-fittingly engaging at least in part into said blocking receptacle of said blocking disk; and
a second blocking element pivotally mounted on said second fitting adapter that is fixed to the second seat element, and spring-loaded by a spring element into the locking setting.

30. The fitting according to claim 29, wherein the second seat element is a backrest.

31. The fitting according to claim 29, wherein, in the locking setting, an angle of friction between a first blocking element and said pawl is greater than an angle of friction between said second blocking element and said pawl.

32. The fitting according to claim 31, wherein said blocking elements are pivotally mounted on a common second bearing point.

33. The fitting according to claim 29, wherein said second blocking element is coupled in terms of actuation to said first blocking element.

34. The fitting according to claim 29, wherein said spring element is one of two spring elements arranged in series with respect to one another in terms of a direction of action thereof.

35. The fitting according to claim 34, wherein a first of said spring elements is formed as a leg spring having first and second spring legs, and wherein said first spring leg is coupled to a first friction lobe, and said second spring leg is coupled to a second friction lobe.
